(19) United States
(12) Patent Application Publication
(10) Pub. No.: US 2012/0295565 A1
(43) Pub. Date: Nov. 22, 2012

(54) SYSTEM AND METHOD FOR ANALOG INTERFERENCE SUPPRESSION IN PULSED SIGNAL PROCESSING

(75) Inventor: Vernon R. Goodman, Rockwall, TX (US)

(73) Assignee: RAYTHEON COMPANY, Waltham, MA (US)

(21) Appl. No.: 13/466,201

(22) Filed: May 8, 2012

Related U.S. Application Data
(60) Provisional application No. 61/486,524, filed on May 16, 2011.

(51) Int. Cl. H04B 1/10

(52) U.S. Cl. 455/296

(57) ABSTRACT

A method for suppressing interference signals within a waveform includes performing an analog Fourier transform on the waveform with a hardware circuit to obtain an amplitude spectrum having a plurality of frequency bins and computing a noise floor spectrum from the amplitude spectrum to obtain a noise floor spectrum; creating a threshold spectrum based on the noise floor spectrum. The method also includes replacing the amplitude of each bin of the amplitude spectrum that exceeds a corresponding bin of the threshold spectrum with an alternative value to form a corrected spectrum and performing an analog inverse Fourier transform on the corrected spectrum thereby suppressing interference signals within the waveform.

### CROSS-REFERENCE TO RELATED APPLICATION

This application is a non-provisional of U.S. patent application Ser. No. 61/486,524, filed May 16, 2011, the disclosure of which is incorporated by reference herein in its entirety.

### BACKGROUND

This disclosure relates generally to signal processing methods and systems. More particularly, this disclosure relates to systems and method for suppressing interference signals using analog circuits.

Interference signals are a major problem in the field of electronic communication signals and, in particular, with radar systems. Coming up with new and improved processes and solutions to reduce or eliminate the unwanted interference signals from the desired signals is a continuing pursuit in the signal processing industry. Continuous Wave (CW) interference is one significant form of interference signal that is typically encountered in a number of Radio Frequency (RF) bands where radar systems operate. The presence of heavy CW interference in these RF bands is created in large part from commercial radio, TV, and cellular telephone transmissions, for example.

In general, CW interference signals introduce a large average power presence into a radar system's passband as compared to the low average power of the desired radar pulses. This results in the desired pulses having a low signal-to-noise ratio (SNR) that makes detection difficult. With the need for a signal-to-noise ratio of 16-18 dB typically required to detect and characterize pulses accurately, standard wideband video detectors are not able to successfully detect pulses on a consistent basis.

Therefore, in order for radar systems to maintain a high-level of proper pulse detection, the CW interference signals must first be suppressed before further signal processing can take place. This suppression should be performed efficiently in order to keep the required computational resources to a minimum. Currently, CW interference signals are typically suppressed through the use of a variety of known CW Interference Suppression (CWIS) techniques based in the frequency domain. Some typical applications are in the Intelligence, Surveillance and Reconnaissance (ISR) field where there is a need to detect various radar pulses in the midst of heavy CW interference. Generally, these CW interference suppression techniques operate to pre-process the data and allow pulse detection via matched detection matrices. However, such techniques are generally time-intensive and require large signal processing systems having special hardware for handling the heavy demand on computational resources.

In view of such, current CW interference suppression techniques are typically not adequate for all of today's CW interference suppression applications, such as those with embedded systems. Embedded systems are one such type of application where there is a growing demand for new and improved techniques for accomplishing CW interference suppression. Embedded systems are generally much smaller in hardware size and have very limited computational resources as compared to the large signal processing systems that typically employed CW interference suppression capabilities. Hence, current frequency-domain based CW interference suppression techniques are just simply too computationally intensive and too resource demanding for use in embedded systems.

Other CW interference suppression techniques have been employed utilizing digitized waveforms, and software based Fast Fourier Transforms (FFTs) and Inverse Fast Fourier transforms (IFFTs) to operate on and process the signals. However, current CW interference techniques employed to digitally process the signals have exhibited problems with the Gibbs Phenomenon. The Gibbs Phenomenon occurs when processing signals that are not infinitely long. Generally, the Gibbs Phenomenon manifests itself in the form of false signal detections, ringing at the ends of pulses, and creation of new pulses which are not actually present in the sensed signal by way of inter-pulse ringing and wrap-around effects. In short, the current CW interference suppression techniques known today in the industry employing digital processing and the use of software based FFTs, inherently carry a two-fold problem of distorted detected pulses and false detections.

Accordingly, there exists a need for an improved CW interference suppression and pulse detection methods and systems that alleviate some or all of the inherent problems known in CW interference suppression systems currently being employed in the signal processing industry.

### SUMMARY OF THE DISCLOSURE

According to one embodiment, a method for suppressing interference signals within a waveform is disclosed. The method of this embodiment includes: performing an analog Fourier transform on the waveform with a hardware circuit to obtain an amplitude spectrum having a plurality of frequency bins; computing a noise floor spectrum from the amplitude spectrum to obtain a noise floor spectrum; creating a threshold spectrum based on the noise floor spectrum; replacing the amplitude of each bin of the amplitude spectrum that exceeds a corresponding bin of the threshold spectrum with an alternative value to form a corrected spectrum; and performing an analog inverse Fourier transform on the corrected spectrum thereby suppressing interference signals within the waveform.

According to another embodiment, a system for suppressing interference signals within a waveform is disclosed. The system of this embodiment includes an analog Fourier transform module that receives the waveform and performs an analog Fourier transform on the waveform to obtain an amplitude spectrum having a plurality of frequency points as well as a noise floor module that computes a noise floor of the amplitude spectrum to obtain a noise floor spectrum. The system of this embodiment further includes a thresholding module that creates a threshold spectrum based on the noise floor spectrum and clips the amplitude spectrum based on the threshold spectrum to obtain a corrected spectrum as well as an analog inverse Fourier transform module that performs an analog inverse Fourier transform on the corrected spectrum thereby suppressing interference signals within the waveform.

According to yet another embodiment, a method for suppressing interference signals within a waveform is disclosed. The method of this embodiment includes: performing in a hardware circuit an analog Fourier transform on the waveform to obtain an amplitude spectrum having a plurality of frequency bins; obtaining a noise floor spectrum based on the amplitude spectrum; creating a threshold spectrum based on the noise floor spectrum; clipping the amplitude spectrum based on the threshold spectrum to obtain a clipped spectrum; and performing an analog inverse Fourier transform on the clipped spectrum thereby suppressing interference signals within the waveform.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE DRAWINGS

The subject matter which is regarded as the invention is particularly pointed out and distinctly claimed in the claims at the conclusion of the specification. The forgoing and other features, and advantages of the invention are apparent from the following detailed description taken in conjunction with the accompanying drawings in which:

FIG. 1 is a block diagram illustrating the various components of one embodiment of a system for continuous wave interference suppression in accordance with the teachings of the present disclosure;

FIG. 2 is a graphical representation of both an amplitude spectrum having continuous wave interference signals present and an amplitude spectrum without interference signals;

FIG. 3 is a flow chart of a method of removing CW Interference from an IF waveform according to one embodiment;

FIG. 4 is a more detailed block diagram of the suppressor module shown in FIG. 1;

FIG. 5 is a block diagram of an analog FT module according to one embodiment;

FIG. 6 is a block diagram of a noise floor module according to one embodiment;

FIG. 7 is a block diagram of a thresholding module according to one embodiment; and

FIG. 8 is a block diagram of an analog inverse FT module according to one embodiment.

Similar reference characters refer to similar parts throughout the several views of the drawings.

### DETAILED DESCRIPTION

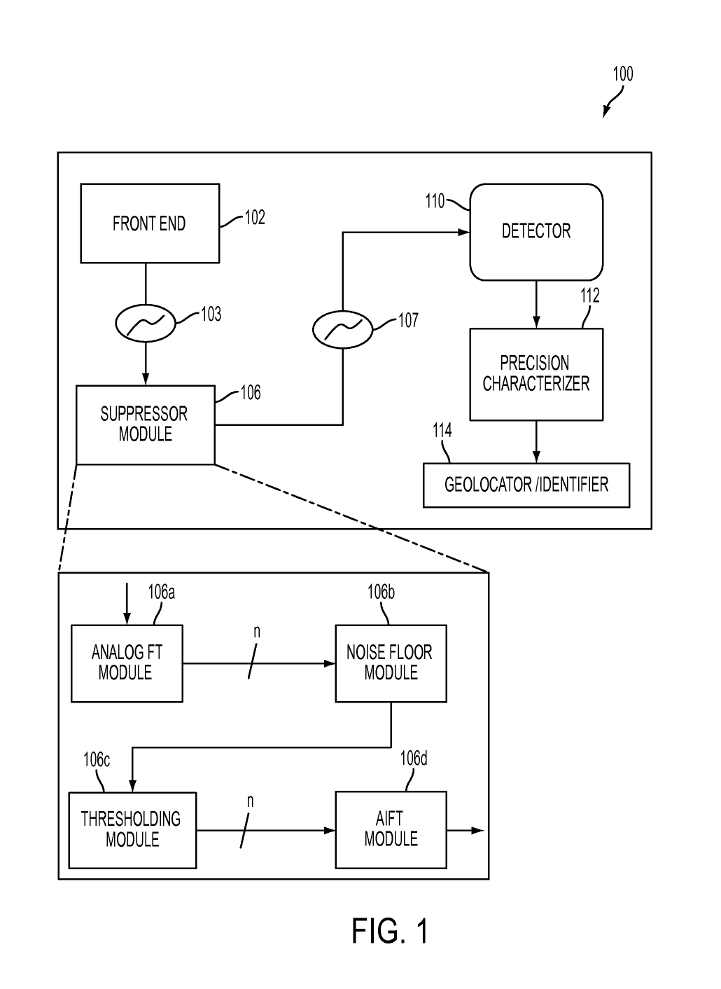

Referring to FIG. 1, there is shown a block diagram illustrating the various components of one embodiment of a system 100 within which continuous wave (CW) interference suppression may be implemented. In one embodiment, system 100 may include a front-end 102, an A/D converter 104, a suppressor module 106, a data store 108, a detector 110, a precision characterizer 112 and a geolocator/identifier 114. In this particular embodiment, the front-end 102 is electrically coupled to, or otherwise in communication with, the A/D converter 104.

The front-end 102 is comprised generally of standard software and hardware electronics commonly used in the industry for transmitting and receiving electronic signals. Alternatively, in another embodiment, the front-end 102 may be equally comprised entirely of software residing in the memory associated with a stand-alone processing system or equally implemented in any of such other form as is generally known and practiced in the electronics and signal processing industry. The stand-alone processing system may be any suitable type of computing system implemented with a processor capable of executing computer program instructions stored in a memory.

In the illustrated embodiment of the system 100, the front-end 102 is generally operable to receive radio frequency waveforms that are present within a targeted environment and produce a corresponding output waveform 103. It shall be understood that the waveforms in the targeted environment may come from reflections of waveforms produced by a transmitter (e.g., either a separate transmitter or the front end 102) off of objects in the environment (active radar) or may simply arise from waveforms generated by the objects themselves (passive radar).

In one embodiment, the front-end 102 may be configured to receive radio frequency (RF) waveforms that are present within a targeted environment and then down-convert them to an intermediate frequency (IF) waveform for further processing. Such down-conversion may be accomplished, for example, by heterodyning the received RF waveforms.

In this particular embodiment of the system 100, the front-end 102 is electrically coupled to, or otherwise in communication with, a suppressor module 106. The suppressor module 106 is preferably operable to receive the down-converted IF waveform 103 (first IF waveform) from the front-end 102 and further process it to suppress any CW interference that may be present and facilitate subsequent detection of desired data pulses by other downstream components within the system 100. The output of the suppressor module 106 is a second IF waveform 107 that may have the same or a different fundamental frequency than the first IF waveform 103. The individual steps of the signal processing performed by suppressor module 106 to suppress the CW interference (e.g., to convert IF signal 103 to IF signal 107) and facilitate subsequent detection of desired data pulses will be further addressed in detail below. In one embodiment, the suppressor module 106 may be further comprised of an analog (hardware) Fourier transform (FT) module 106a, a noise floor module 106b, a thresholding module 106c, and an analog inverse Fourier Transform (AIFT) module 106d. These sub-modules of the suppressor module 106 perform, as described in greater detail below, the interference suppression disclosed herein. In one embodiment, the suppressor module 106 can be added into an embedded system to provide for interference suppression.

In one embodiment, the suppressor module 106, including all of its sub-modules 106a-106d, is implemented in hardware. In other embodiments, some of the sub-modules 106b-106d, may be implemented in the form of one or more Field Programmable Gate Array (FPGA) chip devices having the instruction sets for digital processing pre-programmed, or otherwise burned, into the FPGA(s). Alternatively, in other embodiments, sub-modules 106b-106d, may be implemented entirely of one or more software modules residing in the memory associated with a processing system or may be implemented in any other generally known and practiced form in the electronics and signal processing industry such as, for example, in the form of digital signal processors (DSPs) or application-specific integrated circuits (ASICs).

In one embodiment, the suppressor module 106 is electrically coupled to, or otherwise in communication with, the detector 110. In one embodiment, the detector 110 is operable to receive and analyze data from the suppressor module in real time. The detector 110 may generate, for example, a time-frequency spectrogram image and perform a coarse detection of pulses. In one embodiment, detector 110 may be in the form of any imaged based detector commonly known in the industry and suitable for pulse detection wherein an image background is determined and pixels exceeding a threshold are found. In general, these pixels are then typically tied together to form coarse pulse descriptor words (PDWs). Typical examples of imaged based detectors are generally implemented in the form of FPGA chip devices. Alternatively, in other embodiments, the detector 110 may be equally implemented comprised entirely of software residing in the memory associated with a processing system such as described herein above or equally implemented in any of such other form as is generally known and practiced in the electronics and signal processing industry. Depending on the requirements of the particular application at hand, the system 100 may further include a precision characterizer 112. In such instances, the detector 110 may then be further electrically coupled to, or otherwise in communication with, the precision characterizer 112.

In one embodiment, the precision characterizer 112 is preferably operable to receive the PDWs, along with an identical sample of the digitized and processed waveform output 152 from the suppressor module 106, and perform fine tuning, precise measurements, and modulation characterization. In one embodiment, the precision characterizer 112 may be implemented in the form of an FPGA. Alternatively, in another embodiment, the precision characterizer 112 may be implemented comprised entirely of software residing in the memory associated with a processing system such as described herein above or equally implemented in any of such other form as is generally known and practiced in the electronics and signal processing industry. Still further, depending on the requirements of the particular application at hand, the system 100 may further include a geolocator 114. In such case, the precision characterizer 112 may then be further coupled to, or otherwise in communication with, the geolocator 114. The geolocator 114 is preferably operable to receive the final, fine PDWs from the precision characterizer 112 and perform further processing to determine precision geographical related information. In one embodiment, the geolocator 114 may be implemented in the form of software residing in the memory associated with a processing system such as described herein. Alternatively, in another embodiment, the geolocator 114 may be implemented in the form of one or more FPGAs or any combination of FPGAs and software using industry commonly known combination and decombination techniques, or equally implemented in any of such other form as is generally known and practiced in the electronics and signal processing industry.

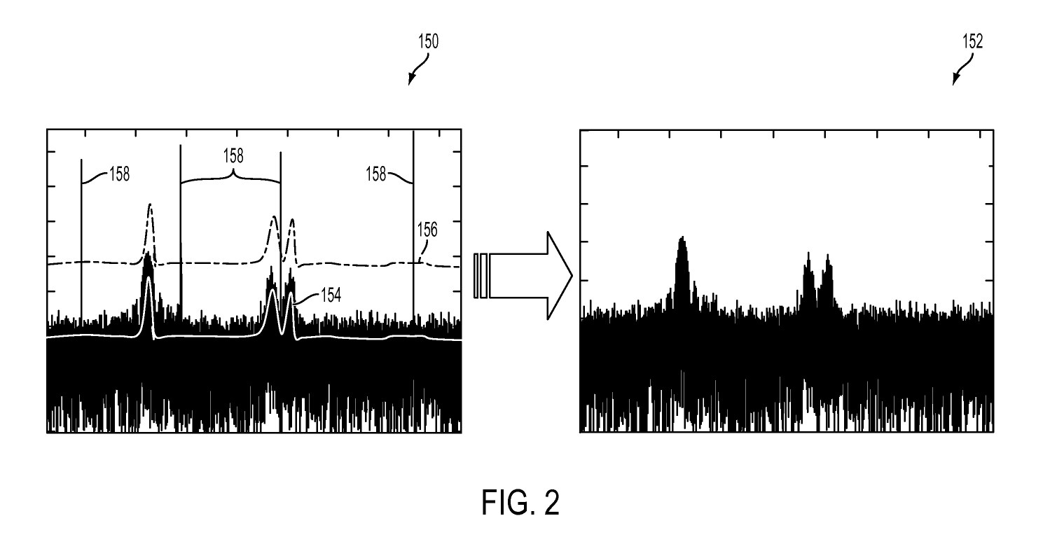

Referring now to FIG. 2, a graphical representation can be seen of an example of a first amplitude spectrum 150 having interference signals 158 present and a spectrum 152 that is the result of removing the interference signals (e.g., a corrected spectrum). When CW suppression processing is not utilized and an amplitude spectrum 150 is subsequently processed through standard industry image detectors, a time-frequency spectrogram may be produced where both data pulses and interference signals are detected leading to false positives. The CW suppression method taught by the present disclosure, will efficiently remove or reduce such interference signals from the amplitude spectrum 150 and its corresponding time-frequency spectrogram to thereby allow clear detection of the data pulses.

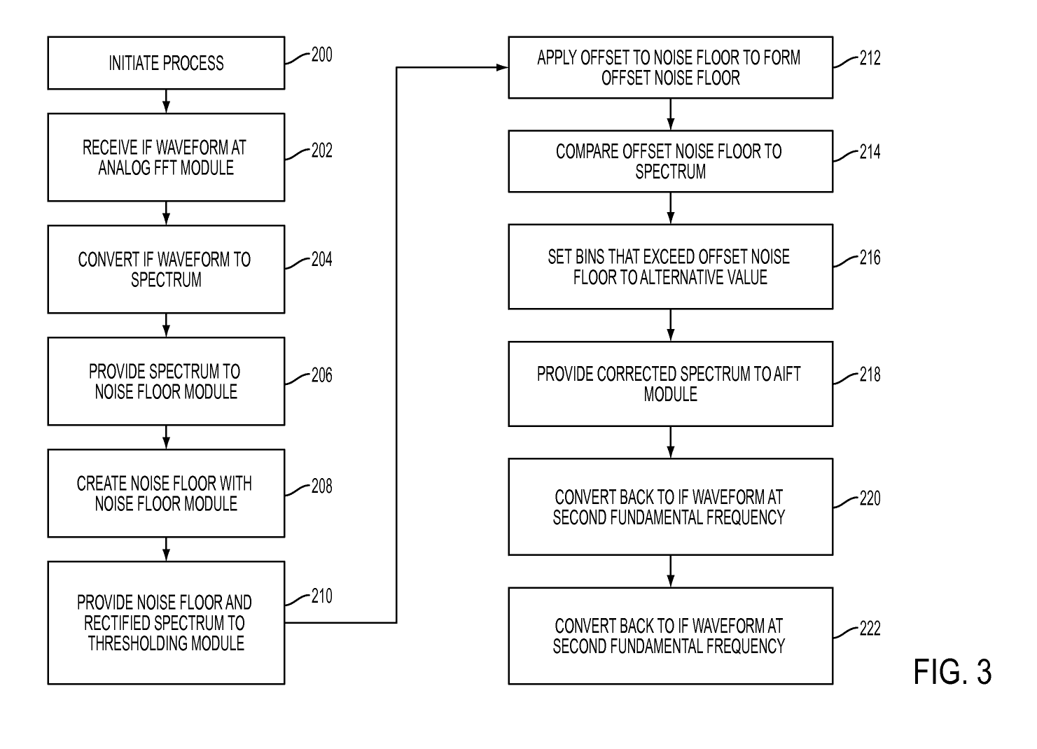

Referring now to FIGS. 1-3, in FIG. 3 a flow chart can be seen showing the details of a method that may be performed by the suppressor module 106 to carry out CW suppression in accordance with the teachings of the present disclosure. At block 200, the process is initiated. The process may be initiated by applying power to and performing any suitable bootstrapping operations to system 100. At block 202, the analog FT module 106a receives the IF waveform from the front end 102 (or a data store if operating off-line). The analog FT module 106a does not include any software in one embodiment.

Regardless of how configured, the analog FT module converts the IF waveform into a spectrum (e.g., spectrum 150) including n frequency bins at block 204 and provides it to the noise floor module 106b at block 206. The number of bins (n) into which the IF waveform is converted will depend on the particular implementation of the analog FFT module 106a and will include upper and lower frequencies that are discussed below. In one embodiment, the number of bins is equal to 128, 256, 1024, 2048, 4096 or 8192. As illustrated, an n-channel spectrum is provided from the analog FT module 106a to the noise floor module 106b. It shall be understood that other signals or copies of modified versions of the n-channel signal could also be provided. Further, it shall be understood that while the connection between the analog FT module 106a and the noise floor module 106b is shown as being n-bits wide, the actually connection could be any type of connection and could include, for example, a serial connection depending on the context.

At block 208, the noise floor module 106b produces a noise floor 154 for the spectrum 150. The noise floor 154 may be produced on a bin by bin basis by, for example, averaging each bin with one or more bins adjacent or near it to form a noise floor value for that bin. In another embodiment, the particular bin of interest is not considered and the noise floor for that bin is the average of bins that are adjacent or near to it. The noise floor module 106b may be implemented in hardware, software, or a combination thereof. In one embodiment, the noise floor 154 is formed from a rectified (detected) version of the spectrum 150 as described in greater detail below.

At block 210 the noise floor and at least a rectified version of the spectrum are provided to the thresholding (or “clipping”) module 106c. The noise floor is provided from the noise floor module 106b and the rectified spectrum can be provided from the noise floor module 106b, the analog FFT module 106a or any other module. At block 212 an offset is applied to the noise floor to create an offset noise floor 156 that is compared to the spectrum 150 at each frequency bin at block 214. These processes can occur, for example, in the thresholding module 106c. In one embodiment, the spectrum to which the offset noise floor 156 is compared is the detected or rectified spectrum. In the event that any bin of the spectrum contains a value (e.g., amplitude) that exceeds that offset noise floor 156 (e.g., peaks 158), at block 216 the value of those bins is set to an alternative value to create the corrected spectrum 152. In one embodiment, the alternative value is zero. In another embodiment, the alternative value for a particular bin is the noise floor for that bin. Comparison of spectrum 150 with corrected (or clipped) spectrum 152 illustrates that the peaks 158 (which most likely represent a CW interference signal) have been removed as a result of the processes performed in blocks 208 to 216. Those bins that do not have amplitudes exceeding the offset noise floor 156 are not modified.

At block 218, an n-bin corrected spectrum (e.g., corrected spectrum 152) is provided to the AIFT module 106d. The AIFT module 106d may include hardware or software to perform an inverse Fourier transform. At block 220 the n-bin corrected spectrum is converted back to an IF waveform 107 having a second fundamental frequency that may be the same or different than the first fundamental frequency of the IF signal received by the analog FT module 106a from the front end 102. At block 220, the second IF waveform is provided to the detector 110 for further processing.

The foregoing description provides a general understanding of the processing that occurs in the suppressor module 106 according to one embodiment. One of ordinary skill will realize that particular manner in which the processing occurs can be varied and that above systems/methods may provide one or more of the following technical effects: an increase in processing speed compared to digital CWIS because at least the FT is performed in hardware rather than software; a 6-10 dB improvement over non-CWIS detection is estimated; longer standoff distances; earlier detection; and better self-protection for high-interference environments. Furthermore, because the FT is performed in hardware, there are no Gibbs phenomenon effects.

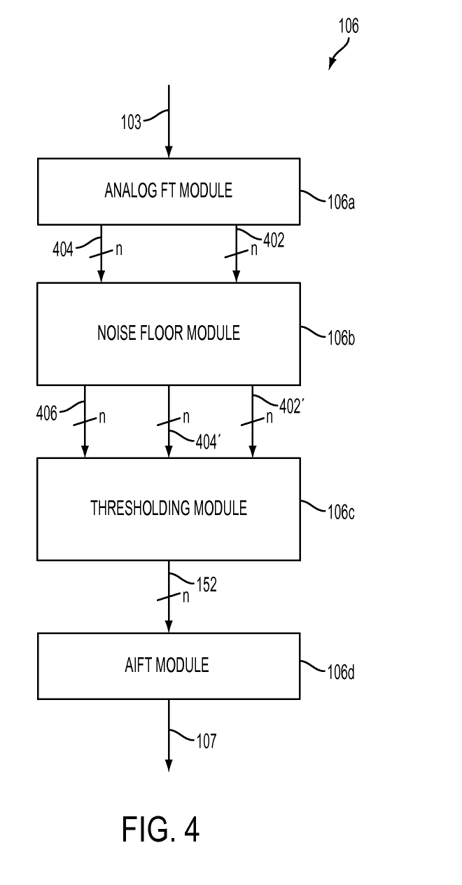

FIG. 4 is a more detailed depiction of the suppressor module 106 that may be implemented in one embodiment. The suppressor module 106, as before, includes analog FT module 106a, noise floor module 106b, thresholding module 106c and AIFT module 106d. While the number of bins shown in various signals are generally shown as n in FIG. 4 and in all subsequent figures, the number of bins can be varied as will be understood by the skilled artisan.

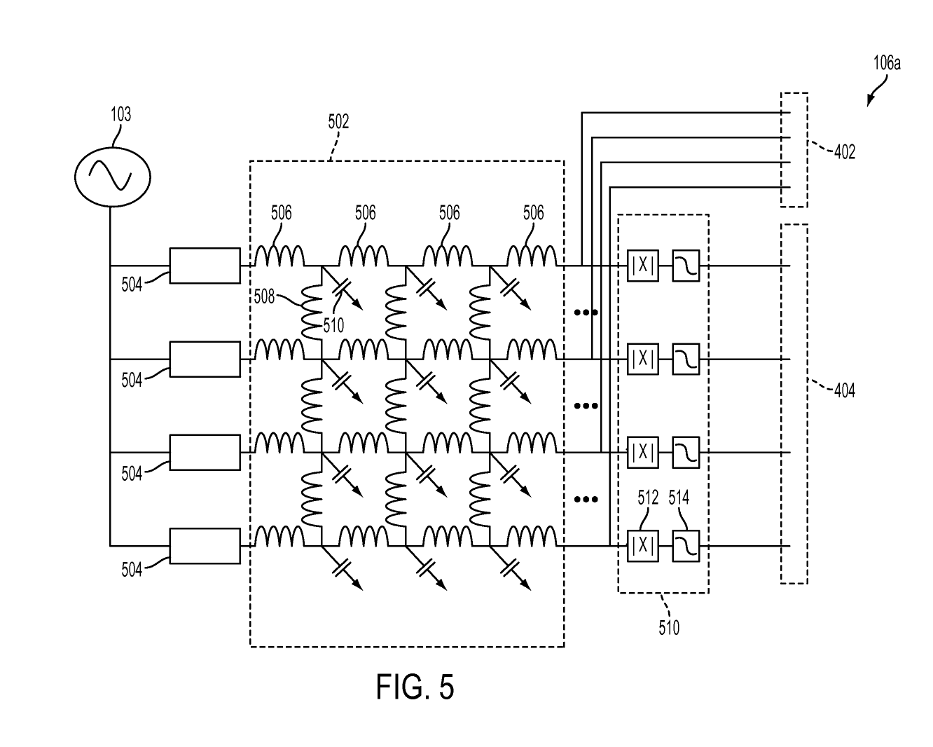

The analog FT module 106a receives the first IF signal 103 and produces both a raw spectrum 402 and a detected (rectified) spectrum 404. Both the raw and detected spectrums 402, 404 are formed of n bins. With reference now to FIG. 5, a more detailed depiction of one embodiment of an analog FT module 106a is illustrated. The illustrated analog FT module 106a includes a transform section 502 and an output conditioning section 510. In one embodiment, the transform section 502 is formed of a lattice of inductors 506, 508 and capacitors 510. In more detail, the transform section includes a plurality of rows of serially connected inductors 506. The number of inductors in each row can be varied. The number of rows is selected to match the desired number of bins of the raw/detected spectrums 402, 404. Each row of the transform section 502 is connected to an adjacent row by connecting inductors 508 in the manner shown in FIG. 5. In addition, the node where the connecting inductors 508 connect to each row also includes a capacitor 510 coupled to the node and ground or another reference voltage. The exact values of the inductors 506, 508 and the capacitors 510 are selected based on the input bandwidth and desired number of output bins. In one embodiment, one or more of the rows of the transform section 502 are coupled to a respective variable attenuator 504 that serves to impart delay from the IF signal 103 to each row. The nature of how such delay can be configured, as well as further description of how the transform section operates can be found in Ultrafast Analog Fourier Transform Using 2-D LC Lattice, Afshari, Bhat, and Hajimiri, IEEE TRANSACTIONS ON CIRCUITS AND SYSTEMS—I: REGULAR PAPERS, Vol. 55, No. 8, September 2008, which is hereby incorporated by reference in its entirety.

The output of the transform section 502 is the raw spectrum 402. The raw spectrum 402 can be conditioned by the output conditioning section 510 to produce the detected spectrum 404. In one embodiment, the detected spectrum 404 is formed by rectifying each bin with a rectifier 512 and then low pass filtering with a filter 514 to produce the conditioned output 404. Of course, in some cases, the filter 514 can be omitted.

Referring again to FIG. 4, the raw 402 and detected spectrum 404 are then provided to the noise floor module 106b. The noise floor module 106b creates a noise floor 406 from the detected spectrum 404. In addition, the noise floor module 106b can impart delays to the raw and detected spectrums 402, 404 to create delayed raw and delayed detected spectrums 402′, 404′.

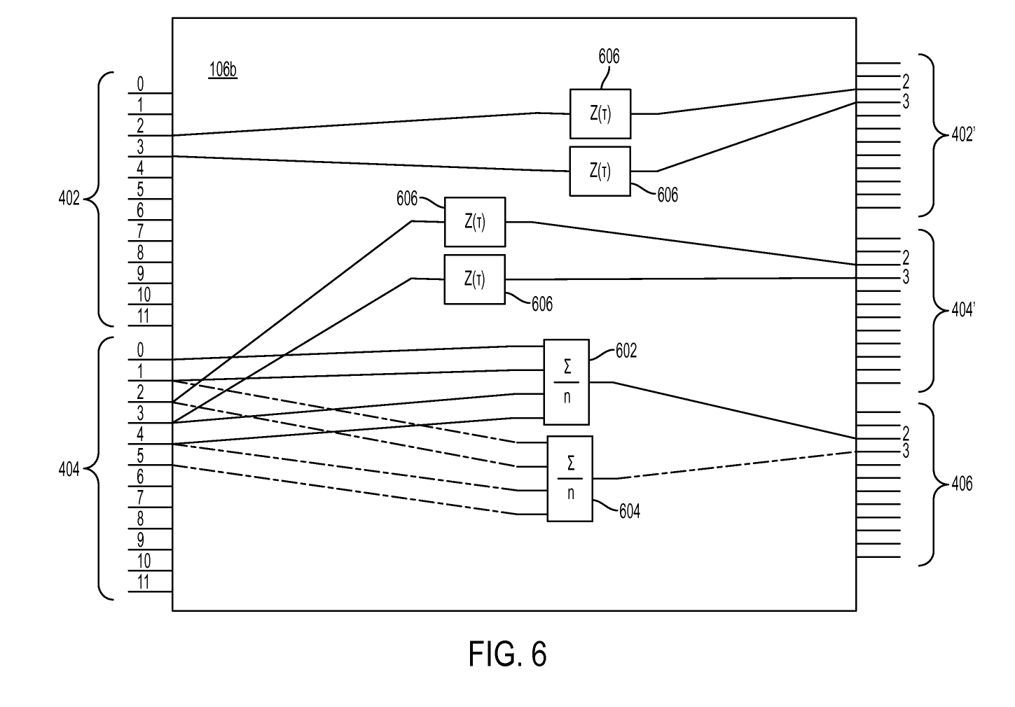

FIG. 6 shows one embodiment of a noise floor module 106b. This embodiment is simplified and illustrates one manner in which a noise floor value 406 for bins 2 and 3 can be created. It shall be understood that each bin can have the same or a similar process performed. In this embodiment, each of the noise floor values is formed by averaging the values of the two adjacent bins on each side of the bin of interest. In particular, the values of bins 0, 1, 3 and 4 are provided to a first averager 602 to form an average therefrom that will be the noise floor value 406 for bin 2. That is, the noise floor value 406 for bin 2 does not include the actual value of bin 2. Similarly, the values of bins 1, 2, 4 and 5 are provided to a second average 604 to form the noise floor value for the bin 3. It shall be understood, however, that different configurations of adjacent or nearby bins could be selected to form the noise floor value 406 for a particular bin and the bin of interest itself could also be included.

Each of the bins of the raw and detected spectrums 402, 404 are delayed by delay modules 606. The amount of delay is selected to match the processing time required by the first and second averagers 602, 604 to form the noise floor values 406 to ensure coherency for later processing. The resulting delayed raw and delayed detected spectrum is shown as spectrums 402′ and 404′ respectively.

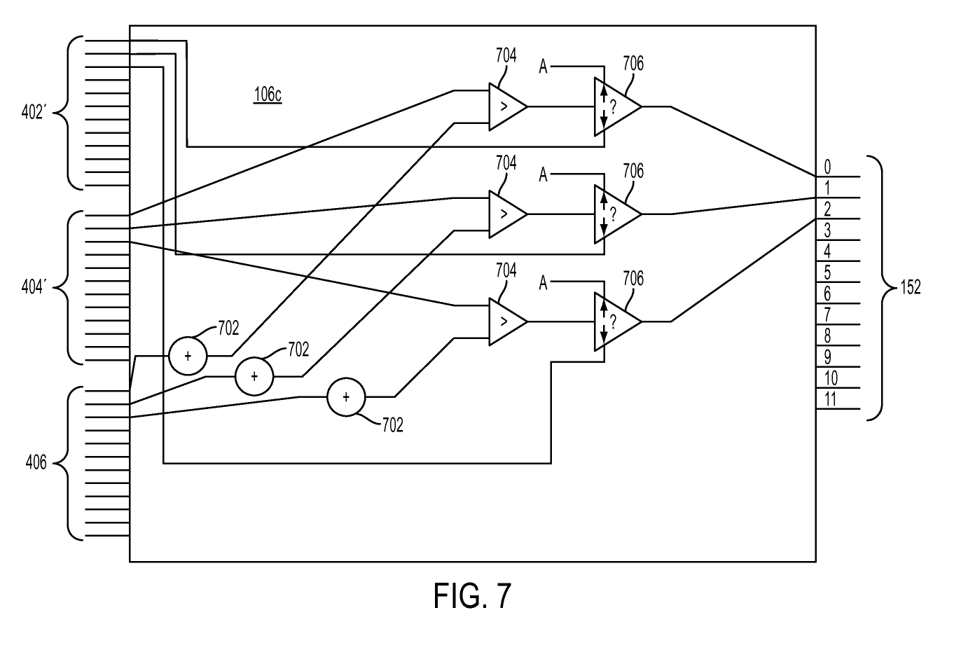

FIG. 7 shows a more detailed depiction of a thresholding module 106c. The thresholding module 106c receives the delayed raw and delayed detected spectrums 402′, 404′ and the noise floor values 406 from the noise floor module 106b (FIGS. 4 and 6) and produces an n-bin corrected spectrum 152. In general, in the event that delayed detected value for a particular bin exceeds the noise floor plus an offset, the delayed detected value is replaced with an alternative value shown by reference character A in FIG. 7.

In more detail, each bin of the noise floor has an offset value added to it by an adder 702 to form a threshold value. The offset value is the same for each bin in one embodiment. The adders 702 could be formed, for example, as voltage biasing circuits in one embodiment. The threshold value for each bin is compared to the amplitude of the corresponding bin of the delayed detected spectrum 404′ by comparators 704. The comparators 704 can be configured to produce a first value (e.g., Vcc supplied to the comparator 704) if the delayed detected spectrum 404′ exceeds the threshold value and a second value (e.g., ground) if it does not.

The output of the comparators 704 are used to select one of two values provided to selector switches 706. In particular, the values provided to the selector switches 706 are the delayed raw spectrum 402′ and the alternative value A. Alternative value A can be 0 in one embodiment or the noise floor 406 for a particular bin in another. The alternative value A is selected (e.g., when the output of the comparator 704 is at the first value) and provided as part of the corrected spectrum 152 when the delayed detected spectrum 404′ exceeds the noise floor 406 which indicates that CW interference is occurring. Otherwise, the value of the delayed raw spectrum 402′ is selected.

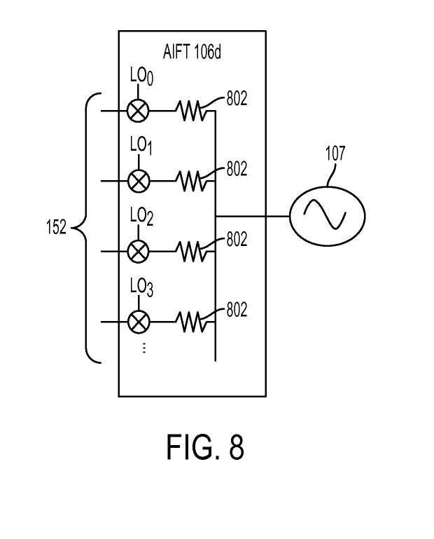

FIG. 8 shows an example of AIFT 106d according to one embodiment. The AIFT 106d receives the corrected spectrum 152 and converts it into a second IF waveform 107 having a second fundamental frequency f₂. Each bin of the corrected spectrum 152 is provided to a respective cell mixer 802. The cell mixers 802 could be, for example, Gilbert cell mixers in one embodiment. The bin values are mixed with a respective oscillating signal LOₓ to produce a plurality of waveforms that all get combined to form IF waveform 107. The frequencies of the various oscillating signals LOₓ can be defined, in one embodiment, as shown below:

LO₀=f_{low}+f₂;

LO₁=(f_{high}−f_{low})/n+f₂;

LO₂=2(f_{high}−f_{low})/n+f₂; and

LO(n−₁)=(n−1)(f_{high}−f_{low})/n+f₂;

where f_{high} and f_{low} are the frequency limits on the first IF signal 103 (FIG. 4).

In one embodiment, a resistor 802 is provided at the output of the mixing cells LOₓ to keep one signal from one mixing cell from interfering with the mixing performed by another mixing cell. Having now produced a corrected IF waveform 107 with CW interference removed, further processing can performed as described above.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or steps plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The flow diagrams depicted herein are just one example. There may be many variations to this diagram or the steps (or operations) described therein without departing from the spirit of the invention. For instance, the steps may be performed in a differing order or steps may be added, deleted or modified. All of these variations are considered a part of the claimed invention.

While the preferred embodiment to the invention had been described, it will be understood that those skilled in the art, both now and in the future, may make various improvements and enhancements which fall within the scope of the claims which follow. These claims should be construed to maintain the proper protection for the invention first described.

What is claimed is:

1. A method for suppressing interference signals within a waveform, comprising:
performing an analog Fourier transform on the waveform with a hardware circuit to obtain an amplitude spectrum having a plurality of frequency bins;
computing a noise floor spectrum from the amplitude spectrum to obtain a noise floor spectrum;
creating a threshold spectrum based on the noise floor spectrum;
replacing the amplitude of each bin of the amplitude spectrum that exceeds a corresponding bin of the threshold spectrum with an alternative value to form a corrected spectrum; and
performing an analog inverse Fourier transform on the corrected spectrum thereby suppressing interference signals within the waveform.

2. The method of claim 1, wherein the noise floor spectrum is computed from a rectified version of the amplitude spectrum.

3. The method of claim 2, wherein the alternative value is equal to zero.

4. The method of claim 2, wherein the noise floor spectrum is formed of a plurality of noise floor values corresponding to each bin of the amplitude spectrum and the alternative value is the noise floor value for a bin having its amplitude replaced.

5. The method of claim 2, wherein the noise floor value for a particular bin is created by averaging the amplitude of one or more adjacent bins.

6. The method of claim 5, wherein the noise floor value for a particular bin is created by averaging the amplitude of the particular bin with one or more adjacent bins.

7. The method of claim 1, wherein the amplitude spectrum is in the form of a rectified amplitude spectrum and wherein the step of performing an analog Fourier transform on the waveform further comprises the step of additionally creating a raw amplitude spectrum.

8. The method of claim 7, wherein the step of computing a noise floor spectrum includes computing the noise floor of the rectified amplitude spectrum, and the step of creating a delayed rectified spectrum from the detected spectrum and a delayed raw spectrum from the raw amplitude spectrum.

9. A system for suppressing interference signals within a waveform, comprising:
an analog Fourier transform module that receives the waveform and performs an analog Fourier transform on the waveform to obtain an amplitude spectrum having a plurality of frequency points;
a noise floor module that computes a noise floor of the amplitude spectrum to obtain a noise floor spectrum;
a thresholding module that creates a threshold spectrum based on the noise floor spectrum and clips the amplitude spectrum based on the threshold spectrum to obtain a corrected spectrum; and
an analog inverse Fourier transform module that performs an analog inverse Fourier transform on the corrected spectrum thereby suppressing interference signals within the waveform.

10. The system of claim 9, wherein the analog Fourier transform module produces a raw and a rectified spectrum.

11. The system of claim 10, wherein the thresholding module clips the amplitude spectrum by comparing the rectified amplitude spectrum to the threshold spectrum and, at each of the respective frequency bins where the rectified amplitude spectrum exceeds the threshold spectrum, setting the bin of the raw amplitude spectrum equal to the value of the corresponding bin of the noise floor spectrum.

12. The system of claim 10, wherein the thresholding module creates the threshold spectrum by adding voltage thereto.

13. The system of claim 10, wherein the noise floor module computes the noise floor of the rectified amplitude spectrum to obtain the noise floor spectrum, and further creates a delayed rectified spectrum from the rectified spectrum and a delayed raw spectrum from the raw spectrum.

14. The system of claim 13, wherein the thresholding module clips the amplitude spectrum by comparing the delayed detected amplitude spectrum to the threshold spectrum and, at each of the frequency points of the delayed detected amplitude spectrum that exceeds corresponding frequency points in the threshold spectrum, setting the corresponding respective frequency points of the delayed raw amplitude spectrum equal to zero to thereby form the corrected spectrum.

15. The system of claim 13, wherein the thresholding module clips the amplitude spectrum by way of comparing the delayed detected amplitude spectrum to the threshold spectrum and, at each of the frequency points of the delayed detected amplitude spectrum that exceeds corresponding frequency points in the threshold spectrum, setting the corresponding respective frequency points of the delayed raw amplitude spectrum equal to the noise floor to thereby form the corrected spectrum.

16. The system of claim 13, wherein the delayed detected amplitude spectrum and the delayed raw amplitude spectrum are formed by applying a delay circuit to them.

17. A method for suppressing interference signals within a waveform comprising the steps of:
performing in a hardware circuit an analog Fourier transform on the waveform to obtain an amplitude spectrum having a plurality of frequency bins;
obtaining a noise floor spectrum based on the amplitude spectrum;
creating a threshold spectrum based on the noise floor spectrum;
clipping the amplitude spectrum based on the threshold spectrum to obtain a clipped spectrum; and
performing an analog inverse Fourier transform on the clipped spectrum thereby suppressing interference signals within the waveform.

18. The method of claim 17, wherein the step of obtaining a noise floor spectrum based on the amplitude spectrum further comprises initially creating a second amplitude spectrum identical to the amplitude spectrum, and wherein the step of clipping the amplitude spectrum is comprised of comparing the second amplitude spectrum to the threshold spectrum and, at each of the respective frequency points where the second amplitude spectrum exceeds the threshold spectrum, setting the second amplitude spectrum equal to the noise floor spectrum to thereby obtain the clipped spectrum.

19. The method of claim 17, wherein the amplitude spectrum is in the form of a detected amplitude spectrum and the step of performing an analog Fourier transform on the waveform further comprises the step of additionally creating a raw amplitude spectrum, and wherein the step of obtaining a noise floor spectrum further comprises creating a delayed detected spectrum from the detected spectrum and a delayed raw spectrum from the raw spectrum, and wherein the step of clipping the amplitude spectrum is comprised of comparing the delayed detected amplitude spectrum to the threshold spectrum and, at each of the frequency points of the delayed detected amplitude spectrum that exceeds corresponding frequency points in the threshold spectrum, setting the corresponding respective frequency points of the delayed raw amplitude spectrum equal to zero to thereby form the clipped spectrum.
